(19) United States
(12) Patent Application Publication
(10) Pub. No.: US 2010/0263952 A1
(43) Pub. Date: Oct. 21, 2010

(54) Method and device for operating a hybrid drive

(76) Inventors: Boyke Richter, Karlsruhe (DE); Michael Lehner, Wiernsheim (DE); Herbert Prickarz, Fellbach (DE); Torsten Heidrich, Vaihingen/Enz (DE)

Correspondence Address: KENYON & KENYON LLP, ONE BROADWAY, NEW YORK, NY, 10004, US

(21) Appl. No.: 12/661,724

(22) Filed: Mar. 22, 2010

(30) Foreign Application Priority Data
Apr. 3, 2009 (DE) 10 2009 002 176.0

(51) Int. Cl. B60W 20/00; B60K 6/20; B60W 10/02; B60W 10/10

(52) U.S. Cl. 180/65.275; 180/65.21; 903/946; 903/945

(57) ABSTRACT

A method for operating a hybrid vehicle, which has a first and a second drive unit, in which the second drive unit is started by at least a portion of the operating energy generated by the first drive unit. In order to improve the driving comfort of the hybrid vehicle during the startup of the second drive unit while driving, the second drive unit, which is at rest, is started using kinetic energy obtained from a driving movement of the hybrid vehicle, while the hybrid vehicle is driven by the first drive unit.

### BACKGROUND OF THE INVENTION

1. Field of the Invention

The present invention relates to a method for operating a hybrid vehicle having a first and a second drive unit, in which the second drive unit is started by at least a portion of the operating energy generated by the first drive unit, and to a device for implementing the method.

2. Description of Related Art

Vehicles having a hybrid drive structure are equipped with at least two drive units, which operate according to different principles. In many cases, the hybrid drive structure is formed by an internal combustion engine and an electric motor. Both drive units are thus able to generate the drive torque while the hybrid vehicle is being driven.

Published German patent document DE 35 42 059 C1 describes a motor vehicle having such a hybrid drive structure in which the first drive unit is situated on a main powered axle, and the second drive unit is situated on a connectable powered axle. The motor vehicle also can be moved using only the auxiliary drive in the form of an electric motor. The main drive in the form of an internal combustion engine then is either decoupled or shut down.

It is known to use a starter for starting an internal combustion engine, which can be done both when the vehicle is driving and also when the vehicle is standing still. However, when the motor vehicle is driving, in the case of hybrid vehicles there is also the possibility to start the stationary internal combustion engine by closing the drive train.

When using a double clutch transmission, an input shaft of the transmission is acted upon by the electric motor, a portion of the drive torque provided in this manner being transmitted to the wheels for moving the vehicle, while another portion of the drive torque is transmitted to the internal combustion engine coupled to the input shaft, which is thereby towed along and started in this manner.

### SUMMARY OF THE INVENTION

In comparison with the known approaches, the method according to the present invention for operating a hybrid drive has the advantage that a startup of the second drive unit while driving the hybrid vehicle is possible without being noticed by the driver, so that the driving comfort is not adversely affected. The fact that the second drive unit, which is at rest, is started up by kinetic energy obtained from a driving motion of the hybrid vehicle while the hybrid vehicle is driven by the first drive unit prevents a noise as it becomes noticeable when using a starter, and it also prevents jerking of the vehicle, which occurs when closing the drive train. The jerking of the vehicle is prevented because there is no change in torque at the wheel since no drag torque is present.

In an advantageous manner, the first drive unit drives at least one vehicle axle of the hybrid vehicle directly, whose motion is transmitted to the second drive unit via a transmission. Only the kinetic energy that is provided by the first drive unit and was converted into a movement of the vehicle is used for starting the second drive unit.

In one development, the motion of the directly driven vehicle axle sets a second vehicle axle of the hybrid vehicle in motion, its motion being transmitted for the startup of the second drive unit by way of a transmission. The transmission takes up the kinetic energy of the vehicle axle and transmits it to the second drive unit. In one further specific development, it is possible to dispense with additional components, such as a starter for starting the second drive unit. This exerts less stress on a starter used for starting an internal combustion engine.

An especially comfortable solution is achieved if at least one gear is engaged at the two input shafts of the transmission designed as double-clutch transmission, the input shafts taking up the motion of the hybrid vehicle and transmitting it to the second drive unit for its startup. In this simple manner the drive train of the hybrid train is used counter to the usual direction in that the input shafts of the double-clutch transmission are set into rotary motion from the direction of the first vehicle axle.

In one further development, to transmit the motion to the second drive unit once the gears of the double-clutch transmission have been disengaged, at least one of the clutches that connect an individual input shaft of the double-clutch transmission to the second drive unit in each case is closed. After the gears have been disengaged, the mass inertia of the input shafts by itself is sufficient to start the rotation of the second drive unit, and thus for its start.

The gears of the two input shafts of the double-clutch transmission are advantageously disengaged one after the other. In this way the kinetic energy of a first input shaft of the double-clutch transmission is already able to be transmitted to the second drive unit while the second input shaft is still being acted upon by the vehicle axle with a rotary motion, which it forwards to the second drive unit only after the gear has been disengaged. This ensures that the maximum rotary motion is always transmitted to the second drive unit for its startup.

In one development, the clutches connecting the input shafts of the double-clutch transmission to the second drive unit are closed one after the other. This prolongs the period during which the second drive unit is driven by the input shafts of the double-clutch transmission, because the input shafts transmit their kinetic energy to the second drive unit one after the other in order to ensure a reliable startup.

In one further development, a rotational speed generated by the vehicle axle driven by the first drive unit exceeds a specified value before the second drive unit is started. This ensures that the kinetic energy is definitely sufficient for starting the second drive unit.

In an advantageous manner the kinetic energy for starting the second drive unit is obtained from a direct startup method of the second drive unit designed as internal combustion engine. In such a direct startup method, individual cylinders of the internal combustion engine are already filled with fuel and ignited while the engine is standing still or is operating at a low rotational speed. The torque resulting from the first combustions of the internal combustion engine is sufficient for the further starting of the internal combustion engine.

In one other further development of the present invention, a device for operating a hybrid vehicle has a first and a second drive unit, the second drive unit being started by at least a portion of the operating power supplied by the first drive unit. In order to improve the driving comfort of the hybrid vehicle in the startup of the second drive unit while driving, means are provided, which start the second drive unit, which is at rest, by kinetic energy obtained from a driving motion of the hybrid vehicle, while the hybrid vehicle is driven by the first drive unit. This device has the advantage that it requires no additional components for starting the second drive unit while driving. The disadvantages with regard to the drive comfort related to noise or jerking of the vehicles are eliminated as well. In particular when an internal combustion engine is used as second drive unit, the deactivation of the internal combustion engine during non-use is supported, which reduces the fuel consumption and the CO₂ emission.

In one development the means is a double-clutch transmission, which has two input shafts and one output shaft, and which takes up the kinetic energy provided by the vehicle axle driven by the first drive unit via the output shaft and transmits it to the two input shafts, which are acted upon by different gears, the input shafts being connected to the second drive unit for the startup. The use of a double-clutch transmission makes it possible to store the kinetic energy supplied by the vehicle axle in the rotary motion of the two input shafts, so that sufficient energy is provided for starting the second drive unit.

In one further development, each input shaft is connected to the second drive unit via a clutch, whereby the input shafts are connected to the second drive unit one after the other. This leads to sufficiently long cranking of the second drive unit by the input shafts of the double-clutch transmission.

In an advantageous manner, the first drive unit is situated on a first vehicle axle, and the second drive unit is situated on a second vehicle axle of the hybrid vehicle, the double-clutch transmission being coupled to the second vehicle axle of the hybrid vehicle. The device according to the present invention is able to be used for different system concepts of hybrid vehicles, for instance for a concept in which the first drive unit drives one vehicle axle, while the second drive unit drives a second vehicle axle, the two vehicle axles being mechanically decoupled (axle split hybrid electric vehicle).

The present invention permits numerous specific embodiments. One of them is to be discussed in greater detail with the aid of the figures shown in the drawing.

### BRIEF DESCRIPTION OF THE SEVERAL VIEWS OF THE DRAWINGS

FIG. 1 shows a basic representation of a hybrid concept having a separately driven electrical axis according to the related art.

FIG. 2 shows an exemplary embodiment for the linking of a double-clutch transmission to an internal combustion engine.

FIG. 3 shows a schematic flow chart for the method according to the present invention for the startup of an internal combustion engine.

### DETAILED DESCRIPTION OF THE INVENTION

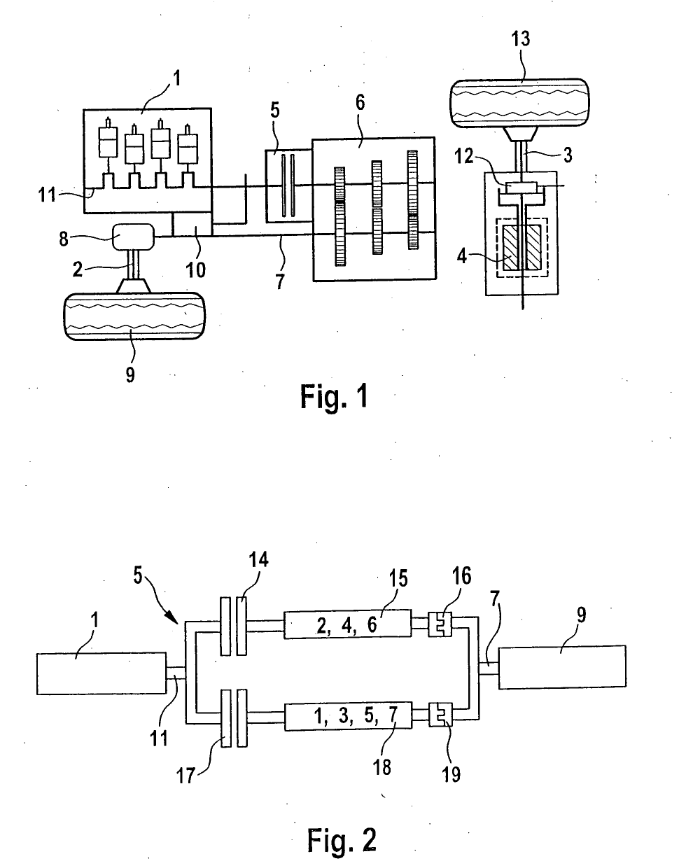

FIG. 1 shows a hybrid concept in which an internal combustion engine 1 drives a first axle 2 of the vehicle, while a second axle 3 of the vehicle is separately driven by an electric motor 4. Via a clutch 5, internal combustion engine 1 leads to a first transmission unit 6, which is connected to a differential 8 via drive shaft 7, which differential forwards the torque to axle 2 on which a wheel 9 is mounted. According to FIG. 1, a starter 10 is connected to a drive shaft 11 of internal combustion engine 1.

Electric motor 4 is mounted together with a second transmission unit 12 on second axle 3 of the vehicle, the torque produced by electric motor 4 being forwarded to a wheel 13, which is driven by second axle 3.

FIG. 2 shows the interaction of internal combustion engine 1 with a drive train, which includes a double-clutch transmission 5, 6, and connects internal combustion engine 1 with wheel 9.

The drive train has two branches, the first branch having a first clutch 14 and a first transmission input shaft 15 of double-clutch transmission 5, 6. Furthermore, next to first transmission input shaft 15 is a dog coupling 16, which is connected to wheel 9 via transmission output shaft 7.

The second branch of the drive train includes a second clutch 17, which leads to a second transmission input shaft 18 of double-clutch transmission 5. Second transmission input shaft 18 is connected to a second dog clutch 19, which likewise leads to wheel 9 via transmission output shaft 7.

Situated on first transmission input shaft 15 are the even gears, such as 2, 4, 6, while odd gears 1, 3, 5, 7 are situated on second transmission input shaft 18. In a driving operation with an active internal combustion engine 1, if a gear is engaged on one transmission input shaft, shifting to the following gear on the inactive shaft is possible already. By shifting the two transmission input shafts 15, 18 with the aid of clutches 14 and 17, rapid shifting of the gear of internal combustion engine 1 takes place.

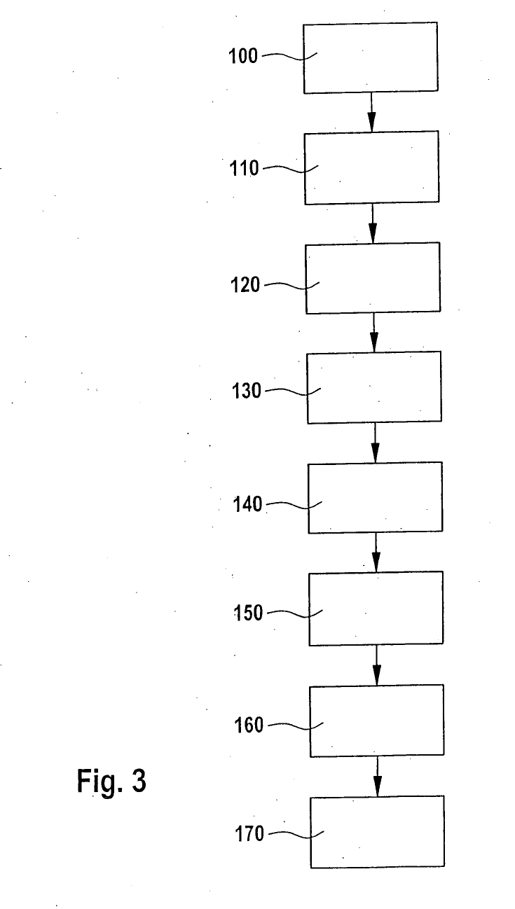

The method according to the present invention is to be explained with the aid of FIG. 3. In block 100, internal combustion engine 1 is switched off. Clutches 14 and 17 of double-clutch transmission 5 are open, while dog clutches 16 and 19 are closed. The driving takes place purely on an electrical basis in that electric motor 4 is driving wheels 13 of second axle 12, first axle 2 having wheels 9 towed. along by second axle 12. Since wheel 9 is connected to double clutch transmission 5 via transmission output shaft 7, first and second transmission input shafts 15 and 18, on which a separate gear is engaged in each case, rotate along due to closed dog clutches 16 and 19. An engine shutoff position of internal combustion engine 1 is known.

In block 110 a decision is made that internal combustion engine 1 is to be started in order to assist electric motor 4 based on the current loading situation. Then, the rotational speed of transmission output shaft 7 is measured (block 120). If the rotational speed of transmission output shaft 7 exceeds a predefined threshold value, an injection into the cylinders of internal combustion engine 1 involved in a direct startup takes place in block 130.

Then, the gears are disengaged at transmission input shafts 15 and 18 in block 140 and dog clutches 16 and 19 are opened. The closing of clutches 14 and 17 takes place in block 150. Clutches 14, 17 are closed in the same sequence in which the gears are disengaged from transmission input shafts 15 and 18 associated with clutches 14, 17. Furthermore, the cylinders involved in the direct startup are fired in block 160, whereupon the start run-up of internal combustion engine 1 takes place in block 170. Drive shaft 11 of internal combustion engine 1 is also set into rotation by rotating transmission input shafts 15 and 18, in alternating manner via clutches 14 and 17. The torque resulting from the first combustions of the cylinders involved in the direct startup supports the beginning rotary motion of drive shaft 11 and thus the startup of internal combustion engine 1.

What is claimed is:

1. A method for operating a hybrid vehicle, which has a first drive unit and a second drive unit, comprising: driving the hybrid vehicle by the first drive unit, and starting the second drive unit, which is at rest, using kinetic energy obtained from a driving motion of the hybrid vehicle.

2. The method as recited in claim 1, wherein the first drive unit directly drives at least one vehicle axle of the hybrid vehicle, whose movement is transmitted to the second drive unit with the aid of a transmission.

3. The method as recited in claim 2, wherein the movement of the directly driven vehicle axle sets a second vehicle axle of the hybrid vehicle in motion, and its movement drives an output shaft of the transmission for the startup of the second drive unit.

4. The method as recited in claim 2, wherein a gear is engaged at two input shafts of the transmission designed as double-clutch transmission, the input shafts taking up the movement of the hybrid vehicle and transmitting it to the second drive unit for its startup.

5. The method as recited in claim 3, wherein a gear is engaged at two input shafts of the transmission designed as double-clutch transmission, the input shafts taking up the movement of the hybrid vehicle and transmitting it to the second drive unit for its startup.

6. The method as recited in claim 4, wherein after disengagement of gears of the double-clutch transmission, at least one of the clutches that connect one input shaft of the double-clutch transmission to the second drive unit in each case is closed in order to transmit the movement to the second drive unit.

7. The method as recited in claim 5, wherein after disengagement of gears of the double-clutch transmission, at least one of the clutches that connect one input shaft of the double-clutch transmission to the second drive unit in each case is closed in order to transmit the movement to the second drive unit.

8. The method as recited in claim 6, wherein the gears of the two input shafts of the double-clutch transmission are disengaged one after the other.

9. The method as recited in claim 7, wherein the gears of the two input shafts of the double-clutch transmission are disengaged one after the other.

10. The method as recited in claim 6, wherein the clutches connecting the input shafts of the double-clutch transmission with the second drive unit are closed one after the other.

11. The method as recited in claim 7, wherein the clutches connecting the input shafts of the double-clutch transmission with the second drive unit are closed one after the other.

12. The method as recited in claim 2, wherein the rotational speed generated by the vehicle axle driven by the first drive unit exceeds a predefined value before the second drive unit is started.

13. The method as recited in claim 1, wherein the kinetic energy for starting the second drive unit is obtained from a direct startup method of the second drive unit designed as internal combustion engine.

14. A device for operating a hybrid vehicle in which a second drive unit is started by at least a portion of operating energy supplied by a first drive unit, comprising: a first drive unit, a second drive unit, and means for starting the second drive unit, which is at rest, using kinetic energy obtained from a driving movement of the hybrid vehicle, while the hybrid vehicle is driven by the first drive unit.

15. The device as recited in claim 14, wherein the means for starting is a double-clutch transmission, which has two input shafts and an output shaft, and which takes up the kinetic energy supplied by a vehicle axle driven by the first drive unit via the output shaft and transmits it to the two input shafts, which are acted upon by different gears, the input shafts being connected to the second drive unit for the startup.

16. The device as recited in claim 15, wherein each input shaft is connected to the second drive unit via a clutch.

17. The device as recited in claim 15, wherein the first drive unit is situated on a first vehicle axle, and the second drive unit is situated on a second vehicle axle of the hybrid vehicle, and wherein the double-clutch transmission is coupled to the second vehicle axle of the hybrid vehicle.

18. The device as recited in claim 16, wherein the first drive unit is situated on a first vehicle axle, and the second drive unit is situated on a second vehicle axle of the hybrid vehicle, and wherein the double-clutch transmission is coupled to the second vehicle axle of the hybrid vehicle.
